(19) United States
(12) Patent Application Publication
(10) Pub. No.: US 2021/0027254 A1
(43) Pub. Date: Jan. 28, 2021

(54) MAINTENANCE MANAGEMENT APPARATUS, SYSTEM, METHOD, AND NON-TRANSITORY COMPUTER READABLE MEDIUM

(71) Applicant: NEC Platforms, Ltd., Kawasaki-shi, Kanagawa (JP)

(72) Inventor: Ryo SUZUKI, Kanagawa (JP)

(73) Assignee: NEC Platforms, Ltd.,, Kawasaki-shi, Kanagawa (JP)

(21) Appl. No.: 16/969,023

(22) PCT Filed: Nov. 16, 2018
(86) PCT No.: PCT/JP2018/042517

§ 371 Date: Aug. 11, 2020

(30) Foreign Application Priority Data
Feb. 13, 2018 (JP) 2018-023017

(51) Int. Cl. G06Q 10/00; G06F 16/28; G06F 11/34; G06F 11/30

(52) U.S. Cl. CPC G06Q 10/20; G06F 11/3006; G06F 11/3476; G06F 16/285

(57) ABSTRACT

A maintenance management apparatus according to the present disclosure includes a storage unit configured to store log identifiers for identifying log information, and time information of the log information while associating them with each other, and an analyzing unit configured to create a log sequence in which the plurality of log identifies are arranged based on the time information, calculate a sequence time from a difference between a start time of the log sequence and an end time thereof, and group the log sequence into a sequence group in which the log sequence and the sequence time are associated with each other. When the sequence group matches neither with a pre-registered normal sequence group nor with a pre-registered abnormal sequence group, the analysis unit calculates a predicted incident occurrence time based on a sequence group having a highest matching rate with the sequence group among pre-registered incident sign groups.

### TECHNICAL FIELD

The present invention relates to a maintenance management apparatus, a system, a method, and a program. In particular, the present invention relates to a maintenance management apparatus, a system, a method, and a program capable of predicting an occurrence of an incident.

### BACKGROUND ART

In information processing systems, it is becoming increasingly important to continuously operate such information processing systems, i.e., to ensure availability thereof. However, in the maintenance and management of such information processing systems, there has been a problem that it is difficult to detect a sign of an incident and predict an occurrence of the incident. In particular, there has been a problem that when an unknown incident that has never occurred in the past has newly occurred, a countermeasure for it is often delayed.

Patent Literature 1 discloses that from a correlation of logs output by a system to be monitored, a change in a correlation that reflects a change in a system state of the system to be monitored is monitored/detected. Further, Patent Literature 1 discloses that through processing performed by a monitoring system, a pair (a combination) of logs of which a correlation value from a log at the normal state output by the system to be monitored is equal to or larger than a predetermined value is selected as a pair of logs to be monitored. Further, Patent Literature 1 discloses that: a log of an OS (Operating System) or middleware collected from each of the apparatuses constituting the system to be monitored is analyzed; a word or a compound word such as an idiomatic phrase (i.e., a linguistic expression) contained in the log, or a computer-specific expression such as an IP (Internet Protocol) address contained in the log is extracted and registered in a dictionary; and ID (IDentification) is assigned to the registered expression. However, Patent Literature 1 does not disclose that a sign of an incident in the system is detected.

Patent Literature 2 discloses that in a log analysis system, when a structural pattern of a log matches neither with a normal pattern nor with an abnormal pattern, the log and reference information associated with the log are output to an abnormal pattern generation unit. Further, Patent Literature 2 discloses that the abnormal pattern generation unit generates an abnormal pattern from the received log in accordance with a determination condition. However, Patent Literature 2 does not disclose that a sign of an incident in the system is detected.

Patent Literature 3 discloses that a determination condition learning processing unit performs: a first step of retrieving events that have occurred in a predetermined period registered in an event information table; a second step of retrieving, among the events retrieved in the first step, events the types of which are information or warning; a third step of calculating “the number of minutes until the occurrence” of the events retrieved in the second step by using a calculation formula; a fourth step of grouping the events of which “the number of minutes until the occurrence” thereof has been calculated in the third step according to a host name, and thereby creating a same-host group; a fifth step of registering records of the events, of which the same-host group has been created in the fourth step, in a sign information table together with initial values of a score “5” and use “o”; and by doing so, grouping host names that have occurred within the predetermined period and registering the initial values of the score “5” and the use “0” in the sign information table. However, Patent Literature 3 does not disclose that a sign of an incident in the system is detected.

### CITATION LIST

### Patent Literature

Patent Literature 1: International Patent Publication No. WO2017/037801

Patent Literature 2: International Patent Publication No. WO2016/132717

Patent Literature 3: Japanese Unexamined Patent Application Publication No. 2016-201060

### SUMMARY OF INVENTION

### Technical Problem

As described above, in the maintenance and management of an information processing system, there has been a problem that it is difficult to detect a sign of an incident and predict an occurrence of the incident.

An object of the present disclosure is to provide a maintenance management apparatus, a system, a method, and a program for solving at least one of the above-described problems.

### Solution to Problem

A maintenance management apparatus according to the present disclosure includes:

a collection unit configured to collect log information;

a storage unit configured to store log identifiers for identifying the log information, and time information of the log information while associating them with each other; and

an analyzing unit configured to create a log sequence in which the plurality of log identifies are arranged based on the time information, calculate a sequence time from a difference between a start time of the log sequence and an end time thereof, and group the log sequence into a sequence group in which the log sequence and the sequence time are associated with each other, in which

when the sequence group matches neither with a pre-registered normal sequence group nor with a pre-registered abnormal sequence group, the analysis unit calculates a predicted incident occurrence time based on a sequence group having a highest matching rate with the sequence group among pre-registered incident sign groups, the predicted incident occurrence time being a predicted time until an occurrence of an incident.

A system according to the present disclosure includes a maintenance management apparatus installed in a customer site, and a maintenance management apparatus installed in a maintenance center, the maintenance management apparatus installed in the maintenance center being connected to the maintenance management apparatus installed in the customer site, in which

the maintenance management apparatus installed in the maintenance center includes:

a collection unit configured to collect log information;

a storage unit configured to store log identifiers for identifying the log information, and time information of the log information while associating them with each other; and

an analyzing unit configured to create a log sequence in which the plurality of log identifies are arranged based on the time information, calculate a sequence time from a difference between a start time of the log sequence and an end time thereof, and group the log sequence into a sequence group in which the log sequence and the sequence time are associated with each other, and

when the sequence group matches neither with a pre-registered normal sequence group nor with a pre-registered abnormal sequence group, the analysis unit calculates a predicted incident occurrence time based on a sequence group having a highest matching rate with the sequence group among pre-registered incident sign groups, the predicted incident occurrence time being a predicted time until an occurrence of an incident.

A method according to this disclosure includes:

collecting log information;

storing log identifiers for identifying the log information, and time information of the log information while associating them with each other; and

creating a log sequence in which the plurality of log identifies are arranged based on the time information, calculating a sequence time from a difference between a start time of the log sequence and an end time thereof, and grouping the log sequence into a sequence group in which the log sequence and the sequence time are associated with each other, in which

when the sequence group matches neither with a pre-registered normal sequence group nor with a pre-registered abnormal sequence group, a predicted incident occurrence time is calculated based on a sequence group having a highest matching rate with the sequence group among pre-registered incident sign groups, the predicted incident occurrence time being a predicted time until an occurrence of an incident.

A program according to this disclosure causes a computer to:

collect log information;

store log identifiers for identifying the log information, and time information of the log information while associating them with each other; and

create a log sequence in which the plurality of log identifies are arranged based on the time information, calculate a sequence time from a difference between a start time of the log sequence and an end time thereof, and group the log sequence into a sequence group in which the log sequence and the sequence time are associated with each other, in which

when the sequence group matches neither with a pre-registered normal sequence group nor with a pre-registered abnormal sequence group, a predicted incident occurrence time is calculated based on a sequence group having a highest matching rate with the sequence group among pre-registered incident sign groups, the predicted incident occurrence time being a predicted time until an occurrence of an incident.

### Advantageous Effects of Invention

According to the present disclosure, it is possible to provide a maintenance management apparatus, a system, a method, and a program capable of predicting an occurrence of an incident.

### BRIEF DESCRIPTION OF DRAWINGS

FIG. 1 is a block diagram showing an example of a maintenance management apparatus according to an example embodiment;

FIG. 2 is a block diagram showing an example of a system according to an example embodiment;

FIG. 3 is a flowchart showing an example of operations performed by a maintenance management apparatus according to an example embodiment;

FIG. 4 is a schematic diagram showing an example of an aspect in which log information according to an example embodiment is analyzed;

FIG. 5 is a flowchart showing an example of operations performed by a maintenance management apparatus according to an example embodiment;

FIG. 6 is a schematic diagram showing an example of an aspect in which log information according to an example embodiment is analyzed;

FIG. 7 is a flowchart showing an example of operations performed by a maintenance management apparatus according to an example embodiment; and

FIG. 8 is a schematic diagram showing an example of an aspect in which log information according to an example embodiment is analyzed.

### DESCRIPTION OF EMBODIMENTS

Example embodiments according to the present invention will be described hereinafter with reference to the drawings. The same symbols are assigned to the same or corresponding component throughout the drawings, and redundant descriptions are omitted as appropriate for clarifying the descriptions.

### EXAMPLE EMBODIMENT

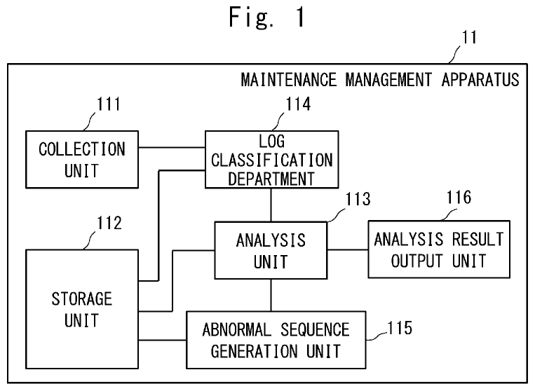

FIG. 1 is a block diagram showing an example of a maintenance management apparatus according to an example embodiment.

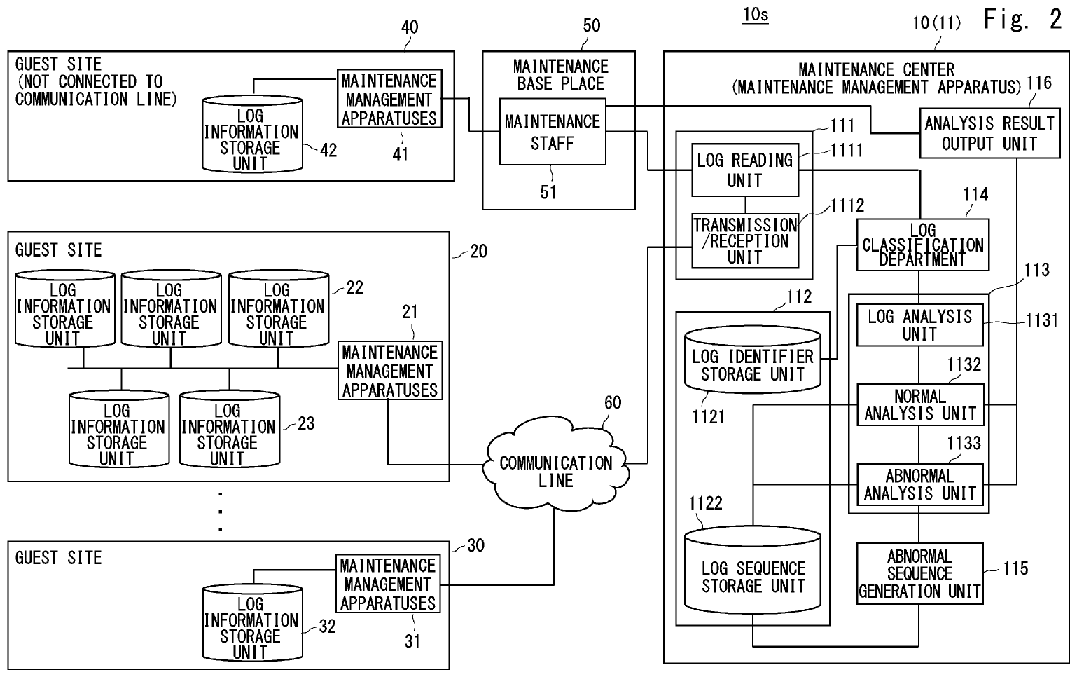

FIG. 2 is a block diagram showing an example of a system according to an example embodiment.

As shown in FIGS. 1 and 2, a system 10s includes a maintenance management apparatus 11 installed in a maintenance center 10 and a maintenance management apparatus 21 installed in a guest site 20. Further, the system 10s also includes a maintenance management apparatus 31 installed in a guest site 30 and a maintenance management apparatus 41 installed in a guest site 40. The maintenance management apparatus 11 is connected to the maintenance management apparatuses 21 and 31. The guest site is also referred to as a customer site.

The maintenance management apparatus 11 is connected to the maintenance management apparatuses 21 and 31 through a communication line 60. The maintenance management apparatus 11 collects maintenance information including log information and the like of the guest site 20 from the maintenance management apparatus 21 through the communication line 60. Further, the maintenance management apparatus 11 collects maintenance information including log information and the like of the guest site 30 from the maintenance management apparatus 31 through the communication line 60.

Since the maintenance management apparatus 41 is not connected to the communication line 60, a maintenance staff 51 of a maintenance base place 50 collects maintenance information including log information and the like of the customer site 40 by using the maintenance management apparatus 41. The maintenance management apparatus 11 collects the maintenance information including log information and the like of the customer site 40 collected by the maintenance staff 51.

The maintenance management apparatus 11 includes a collection unit 111, a storage unit 112, an analysis unit 113, a log classification unit 114, an abnormal sequence generation unit 115, and an analysis result output unit 116.

The collection unit 111 collects various types of log information of each of a plurality of guest sites (i.e., the guest sites 20, 30 and 40). The collection unit 111 includes a log reading unit 1111 and a transmission/reception unit 1112. The transmission/reception unit 1112 collects log information of each of the guest sites 20 and 30 through the communication line 60. In this manner, the transmission/reception unit 1112 periodically collects notification information of a failure event that has occurred in the guest sites 20 and 30, and log information at the time of the occurrence of the failure.

Log information of the customer site 40, which is not connected to the communication line 60, is collected by the maintenance staff 51 dispatched from the maintenance base place 50 and transmitted to the maintenance management apparatus 11. The log reading unit 1111 reads and collects the maintenance information including log information and the like of the guest site 40 collected by the maintenance staff 51.

The log classification unit 114 separates the collected log information into tokens. The log information contains a log identifier for identifying the log information and time information that is a time when the log information was collected. The time information is also referred to as a time stamp. The log classification unit 114 classifies the log information by applying a clustering algorithm to information contained in the log information other than the time stamp. The log classification unit 114 refers to a log identifier storage unit 1121 and checks a log identifier corresponding to the received log information. When the corresponding log identifier is not registered, the log classification unit 114 assigns a new log identifier to the received log information.

The storage unit 112 includes the log identifier storage unit 1121 and a log sequence storage unit 1122. The log identifier storage unit 1121 stores the log identifier of the log information classified by the log classification unit 114 and the time information thereof while associating them with each other.

The analysis unit 113 includes a log analysis unit 1131, a normal analysis unit 1132, and an abnormal analysis unit 1133. The log analysis unit 1131 creates a log sequence in which a plurality of log identifiers are arranged based on their time information. That is, the log analysis unit 1131 acquires information about an output order of the log information (the log identifiers) from the time information, and generates a log sequence by sequencing the log identifiers based on the information about the output order. The sequenced log identifiers are referred to as a log sequence.

The log analysis unit 1131 calculates a sequence time from a difference between the start time of the log sequence and the end time thereof. The log analysis unit 1131 groups log sequences into sequence groups in which the log sequences and their sequence times are associated with each other.

That is, the log analysis unit 1131 groups log sequences into sequence groups while incorporating a maximum time from the start of the sequence to the completion thereof into the group. The grouped log sequences (the sequence groups) are stored in the log sequence storage unit 1122. The sequence time is the maximum time from the start of the sequence to the completion thereof. The sequence time may also be referred to as a sequence maximum time or a sequence completion maximum time.

The normal analysis unit 1132 compares the sequence group with a pre-stored normal sequence group while shifting the sequence group a predetermined time at a time until the sequence time, and thereby calculates a matching rate against the normal sequence group. That is, the normal analysis unit 1132 compares the sequence group with the normal sequence group while shifting the sequence group a predetermined time at a time from the sequence start time to the sequence end time. The normal analysis unit 1132 determines that a sequence group that matches the normal sequence group is normal.

The abnormal analysis unit 1133 determines whether or not a sequence group that does not match the normal sequence group matches a pre-stored abnormal sequence group. Specifically, the abnormal analysis unit 1133 compares the sequence group with the pre-stored abnormal sequence group while shifting the sequence group a predetermined time at a time until the sequence time, and thereby calculates a matching rate against the abnormal sequence group.

The abnormal analysis unit 1133 determines that a sequence group only a part of which matches the normal sequence group and the remaining part of which does not match the normal sequence group is abnormal. Further, the abnormal analysis unit 1133 may determine that a sequence group that does not match the normal sequence group and matches the abnormal sequence group is abnormal.

When the sequence group does not match the pre-registered normal sequence group and does not match the pre-registered abnormal sequence group, the analyzing section 113 compares the sequence group with a pre-registered incident sign group.

The analysis unit 113 calculates a matching rate by comparing the sequence group with the incident sign group while shifting the sequence group and the incident sign group a predetermined time at a time until the sequence time.

Based on the result of the comparison, the analysis unit 113 calculates a predicted incident occurrence time, which is a predicted time until an occurrence of an incident, based on a sequence group having the highest matching rate with the sequence group among the incident sign groups.

The normal sequence group is a sequence group that has normally worked from the start of the sequence to the completion thereof. The abnormal sequence group is a sequence group of which the sequence has stopped for some reason (such as due to an occurrence of an incident) during the period from the start of the sequence to the completion thereof and hence has not normally worked.

The incident sign group is a sequence group that is included neither in the normal sequence group nor in the abnormal sequence group. The incident sign group includes a sequence group for which no incident occurred in the past, but for which there is a high possibility that a new incident will occur in the future and hence which is likely to become an abnormal sequence group.

When a new incident that did not occurred in the past has occurred, the abnormal sequence generation unit 115 generates the sequence for which this incident has occurred as one of new abnormal sequence groups. Further, the abnormal sequence generation unit 115 generates an incident sign group for which there is a high possibility that a new incident will occur in the future and hence which is likely to become an abnormal sequence group.

When the sequence group which the abnormal analysis unit 1133 has determined to be abnormal is not stored in the log sequence storage unit 1122, the abnormal sequence generation unit 115 generates a new sequence group based on the sequence group determined to be abnormal. Among the generated new sequence groups, those that are earlier than the time of the occurrence the incident are stored as incident sign groups in the log sequence storage unit 1122.

The analysis result output unit 116 outputs and displays the result of the analysis made by the analysis unit 113. The analysis result output unit 116 outputs, for example, the matching rate against the normal log sequence group and the predicted incident occurrence time calculated by the analysis unit 113. Further, the analysis result output unit 116 may display the trigger of the occurrence of the incident and the period in which the abnormal sequence occurred.

When an incident occurs, a maintenance staff of the system 10s collects log information output from the maintenance management apparatus installed in the guest site in order to understand the working and study the cause of the occurrence of the incident. The maintenance staff investigates the cause of the occurrence of the incident by analyzing the collected log information, determining the state, and investigating the cause.

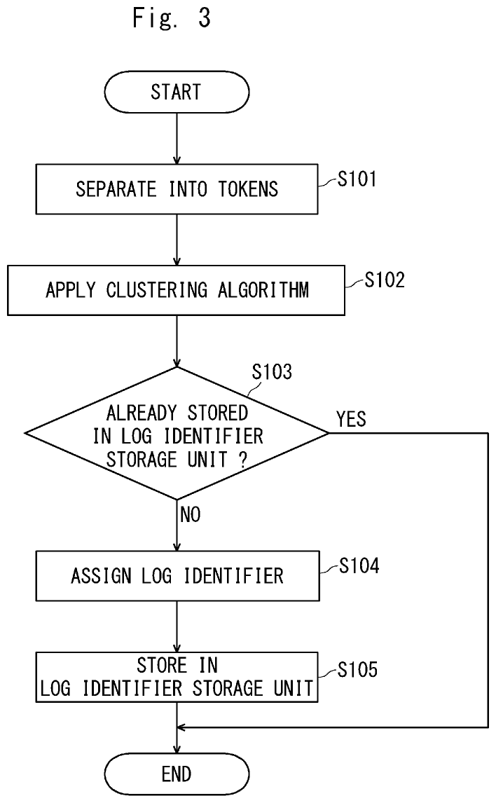

FIG. 3 is a flowchart showing an example of operations performed by the maintenance management apparatus according to the example embodiment.

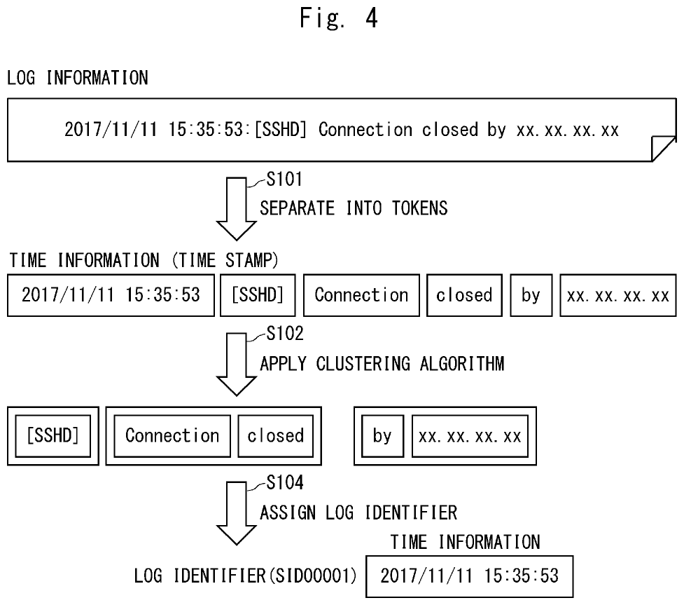

FIG. 4 is a schematic diagram showing an example of an aspect in which log information according to the example embodiment is analyzed.

As shown in FIGS. 3 and 4, when the collection unit 111 receives log information, the log classification unit 114 separates the log information into tokens (step S101). A time “2017/11/11 15:35:53” shown in FIG. 4 is time information (a time stamp) of the log information. The log classification unit 114 applies a clustering algorithm to the log information separated into the tokens (step S102). Once the log information is separated into tokens, some of the tokens are combined again into a plurality of clusters by the log classification unit 114.

The log classification unit 114 refers to the log identifier storage unit 1121 and checks whether or not the log identifier corresponding to the received log information has already been stored (registered) in the log identifier storage unit 1121 (step S103).

When the log identifier corresponding to the received log information has not been registered, the log classification unit 114 assigns a new log identifier to the received log information (step S104). An identifier “SID00001” shown in FIG. 4 is the new log identifier assigned to the log information. The log identifier and the time information are stored and registered in the log identifier storage unit 1121 (step S105).

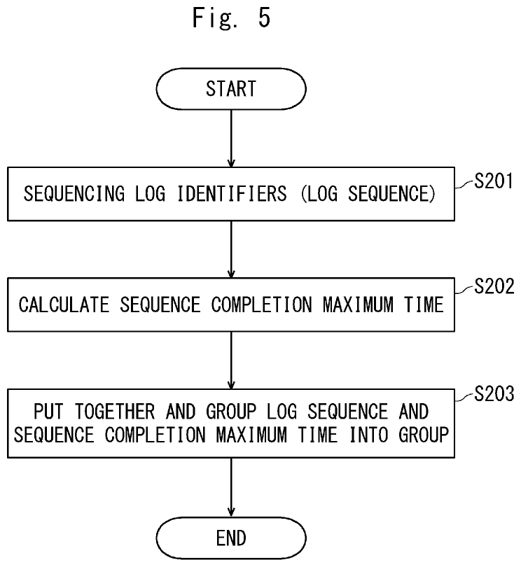

FIG. 5 is a flowchart showing an example of operations performed by the maintenance management apparatus according to the example embodiment.

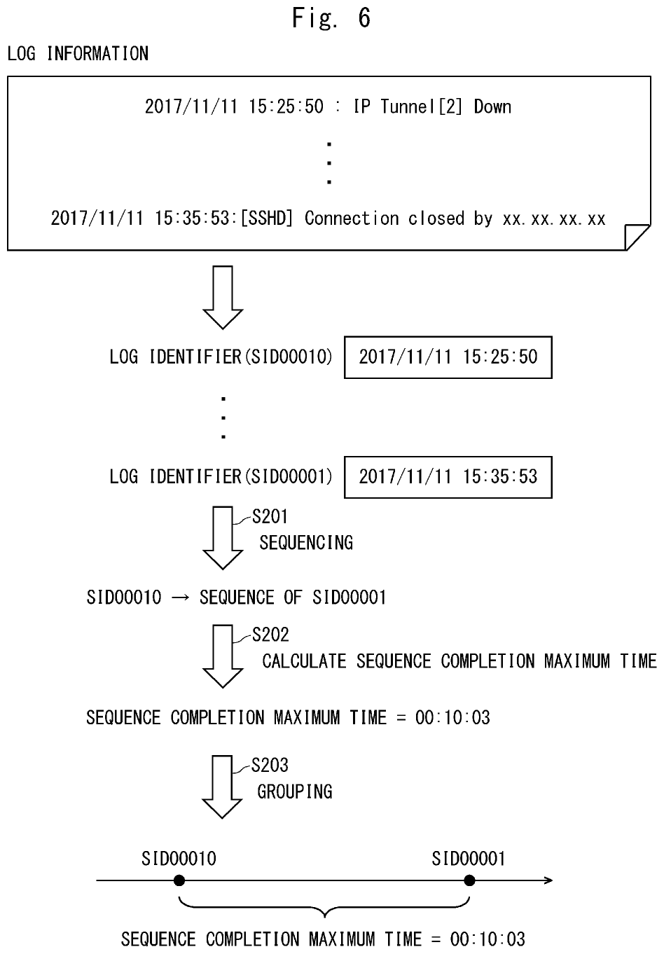

FIG. 6 is a schematic diagram showing an example of an aspect in which log information according to the example embodiment is analyzed;

As shown in FIGS. 5 and 6, the log analysis unit 1131 of the analysis unit 113 sequences the log identifiers according to the output order of the log identifiers and the logs (step S201).

For simplifying the explanation, FIG. 6 shows two log information pieces among the plurality log information pieces. The log identifier of the first log information piece is “SID00010” and the time information thereof is “2017/11/11 15:25:50”. The log identifier of the second log information piece is “SID00001” and the time information thereof is “2017/11/11 15:35:53”. These log information pieces are sequenced as “SID00010->SID00001” in the step S201.

The log analysis unit 1131 calculates a maximum time until the completion of the sequence from a difference between the start time of the log sequence and the end time thereof (step S202). A time “00:10:03” shown in FIG. 6 indicates the maximum time until the completion of the sequence. The maximum time until the completion of the sequence is referred to as a sequence completion maximum time, a sequence maximum time, or a sequence time.

The log analysis unit 1131 puts together and groups log sequences and sequence completion maximum times into a sequence group(s) (step S203). Information “SID00010”, “SID00001” and “00:10:03” shown in FIG. 6 indicate a grouped sequence group.

A sequence group (a log sequence) for which no incident has occurred is determined to be a normal sequence group and is stored (registered) in the log sequence storage unit 1122. The sequence group determined to be the normal sequence group is analyzed by using the normal sequence group in a step S301 (which will be described later).

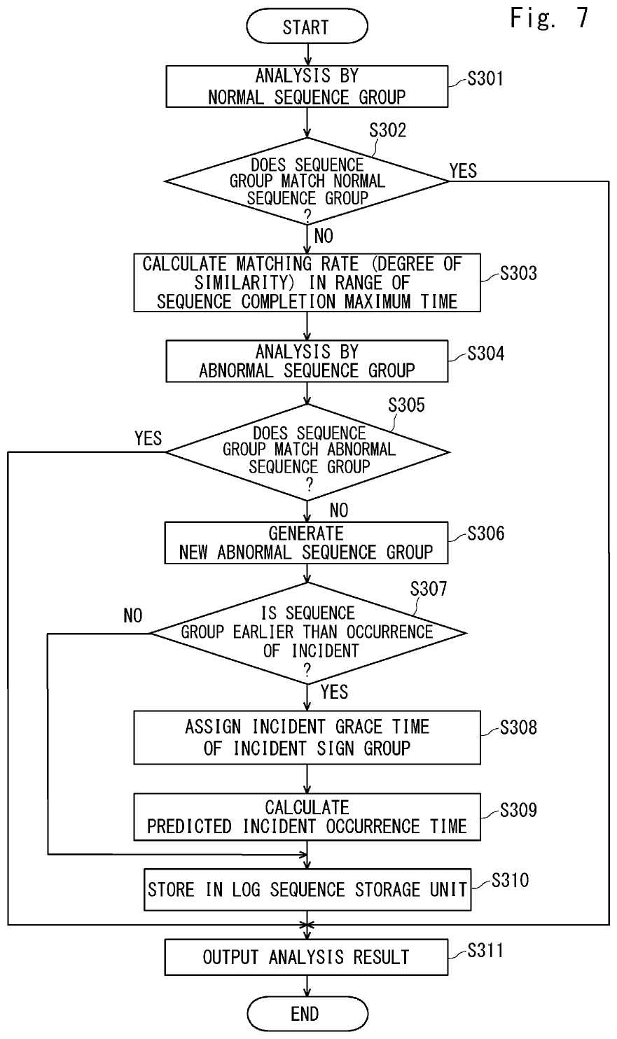

FIG. 7 is a flowchart showing an example of operations performed by the maintenance management apparatus according to the example embodiment.

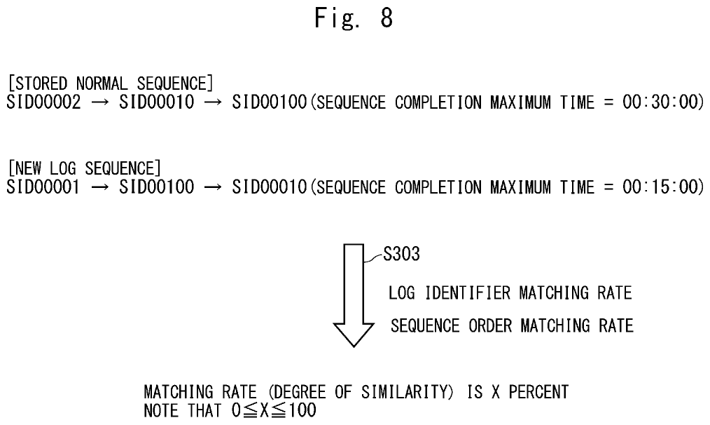

FIG. 8 is a schematic diagram showing an example of an aspect in which log information according to the example embodiment is analyzed;

As shown in FIG. 7, after receiving the sequence group (the log sequence), the normal analysis unit 1132 of the analysis unit 113 refers to the normal sequence group stored in the log sequence storage unit 1122 and analyzes the received sequence group by using the normal sequence group (step S301).

When the received sequence group matches the normal sequence group, the normal analysis unit 1132 determines that the received sequence group is normal (step S302: Yes).

When it is determined that the sequence group is normal (step S302: Yes), the analysis result output unit 116 outputs the result of the analysis indicating that the sequence group is normal (step S311).

When the received sequence group does not match the normal sequence group (step S302: No), the normal analysis unit 1132 calculates a matching rate (a degree of similarity) in the range of the sequence completion maximum time (step S303).

The normal analysis unit 1132 calculates the matching rate between the sequence group and the normal sequence group by comparing them while shifting the sequence group and the normal sequence group a predetermined time at a time until the sequence completion maximum time. The matching rate includes a log identifier matching rate and a sequence order matching rate. The log identifier matching rate is calculated based on the number of matched log identifiers in the sequence group (the Log sequence). The sequence order matching rate is calculated based on the order of matched log identifiers.

Here, as shown in FIG. 8, assume a case where the stored normal sequence group is as follows: “SID00002->SID00010->SID00100”; and the received new sequence group is as follows: “SID00001->SID00100->SID00010”. In such a case, among the three log identifiers in the new sequence group, the identifiers “SID00100” and “SID00010” are also included in the normal sequence group.

Two of the three log identifiers in the new sequence group are the same as those in the normal sequence group. Based on this fact, for example, the log identifier matching rate is calculated as 66.7% (percent).

After the step S303, the abnormal analysis unit 1133 refers to the abnormal sequence group stored in the log sequence storage unit 1122 and analyzes the received sequence group by using the abnormal sequence group (step S304).

When the received sequence group matches the abnormal sequence group, the abnormal analysis unit 1133 determines that the received sequence group is abnormal (step S305: Yes).

When it is determined the received sequence group is abnormal (step S305: Yes), the analysis result output unit 116 outputs the result of the analysis indicating that the received sequence group is abnormal (step S311).

A sequence group that is neither determined to be normal in the step S302 (step S302: No) nor determined to be normal in the step S305 (step S305: No) is a new (unknown) sequence group different from those already present.

The abnormal sequence generation unit 115 adds additional information including the matching rate against the normal sequence group calculated in the step S303 in the unknown sequence group, and thereby generates a new abnormal sequence group based on the unknown sequence group (step S306). That is, when only a part of the received sequence group matches the normal sequence group and none of the received sequence group matches the abnormal sequence group, the abnormal sequence generation unit 115 generates a new abnormal sequence group based on the received sequence group.

After the step S306, the analysis unit 113 determines whether or not the received sequence group is a sequence group that is earlier than the time when the incident occurred (step S307).

The analysis unit 113 stores, among the received sequence groups, a sequence group that is earlier than the time when the incident occurred as an incident sign group in the log sequence storage unit 1122. Unlike the abnormal sequence group, the incident sign group is a sequence group for which no incident occurred in the past, but for which there is a high possibility that a new incident will occur in the future and hence which is likely to become an abnormal sequence group.

The analysis unit 113 additionally adds, in the sequence group that has been defined as the incident sign group, information about the incident sign group (step S308). The information about the incident sign group is, for example, a time difference between the current time and the time of the occurrence of the incident. This time difference may also be referred to as an incident grace time.

When the received sequence group matches an incident sign group that is registered in advance in the log sequence storage unit 1122 (when an identical pre-registered incident sign group is found), the analysis unit 113 calculates a predicted incident occurrence time by performing a statistical analysis (step S309).

The analysis unit 113 may compare the sequence group with the incident sign group, and calculate a predicted incident occurrence time based on a sequence group having the highest matching rate among the incident sign groups.

The sequence group and the predicted incident occurrence time are stored in the log sequence storage unit 1122 (step S310).

Further, the analysis unit 113 may also store a sequence group for which an incident has already occurred as a reference sequence group that is output during the occurrence of the incident or in the postprocessing performed after the occurrence of the incident in the log sequence storage unit 1122.

The analysis result output unit 116 outputs the result of the analysis of the sequence group that has been newly stored in the log sequence storage unit 1122 (step S311).

The output result output by the analysis result output unit 116 is reported to the maintenance staff 51 present in the maintenance center 10 and the maintenance center 50. Therefore, the maintenance staff 51 can immediately start maintenance work after the occurrence of the incident.

Further, the output result includes the incident sign group and the predicted incident occurrence time. Therefore, the maintenance staff 51 can take measures in advance before the incident actually occurs.

The maintenance management apparatus 11 according to the example embodiment calculates the predicted incident occurrence time based on the sequence group having the highest matching rate with the sequence group of the received log sequence among the pre-registered incident sign groups. That is, the maintenance management apparatus 11 predicts an occurrence of an incident by using the incident sign group, calculates a predicted incident occurrence time, and outputs the calculated predicted incident occurrence time. In this way, it is possible to provide a maintenance management apparatus, a system, a method, and a program capable of predicting an occurrence of an incident.

Further, the maintenance management apparatus 11 according to the example embodiment can recognize from which apparatus (which guest site) the received log sequence is transmitted, so that the maintenance management apparatus 11 can identify an apparatus (a place) in which it is predicted that an incident will occur.

Further, the maintenance management apparatus 11 according to the example embodiment stores a log identifier and time information of a log, instead of storing log information, in order to analyze the log. As a result, the maintenance management apparatus 11 can reduce the amount of log information, the storage capacity, and the operation management cost as compared to the case where the whole log information is stored.

Further, since the maintenance management apparatus 11 according to the example embodiment predicts a time when an incident will occur, it is possible to make a maintenance staff 51 stand ready in advance in accordance with the predicted time. In this way, the time from the occurrence of an incident to the solution thereof can be shortened.

Further, the system 10s according to the example embodiment performs maintenance and management of the whole system 10s by using one maintenance management apparatus 11. In this way, the system 10s can reduce the cost for maintenance and management as compared to the case where maintenance and management are performed on a host-by-host basis.

Note that the example embodiment has been described by using an example in which the maintenance management apparatus 11 predicts an occurrence of an incident. However, the present invention is not limited to such an example. The example embodiment can be applied to any kind of information processing systems, information processing apparatuses, and software as long as they have an environment in which a program for analyzing an occurrence of an incident can be executed in a maintenance center 10 or the like.

Although the present invention is described as a hardware configuration in the above-described example embodiments, the present invention is not limited to the hardware configurations. In the present invention, the processes in each component can also be implemented by having a CPU (Central Processing Unit) execute a computer program.

In the above-described example embodiments, the program can be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a CD-ROM (Read Only Memory), a CD-R, and a CD-R/W, and a semiconductor memory (such as a mask ROM, a PROM (Programmable ROM), an EPROM (Erasable PROM), a flash ROM, and a RAM (Random Access Memory)). Further, the program can be supplied to computers by using various types of transitory computer readable media. Examples of the transitory computer readable media include an electrical signal, an optical signal, and an electromagnetic wave. The transitory computer readable media can be used to supply programs to computer through a wire communication path such as an electrical wire and an optical fiber, or wireless communication path.

Note that the invention is not limited to the above-described example embodiments and various changes may be made therein without departing from the spirit and scope of the present invention.

Although the present invention is explained above with reference to example embodiments, the present invention is not limited to the above-described example embodiments. Various modifications that can be understood by those skilled in the art can be made to the configuration and details of the present invention within the scope of the invention.

This application is based upon and claims the benefit of priority from Japanese patent applications No. 2018-023017, filed on Feb. 13, 2018, the disclosure of which is incorporated herein in its entirety by reference.

### REFERENCE SIGNS LIST

10 MAINTENANCE CENTER
10s SYSTEM
11 MAINTENANCE MANAGEMENT APPARATUS
111 COLLECTION UNIT
1111 LOG READING UNIT
1112 TRANSMISSION/RECEPTION UNIT
112 STORAGE UNIT
1121 LOG IDENTIFIER STORAGE UNIT
1122 LOG SEQUENCE STORAGE UNIT
113 ANALYSIS UNIT
1131 LOG ANALYSIS UNIT
1132 NORMAL ANALYSIS UNIT
1133 ABNORMAL ANALYSIS UNIT
114 LOG CLASSIFICATION DEPARTMENT
115 ABNORMAL SEQUENCE GENERATION UNIT
116 ANALYSIS RESULT OUTPUT UNIT
20, 30, 40 GUEST SITE
21, 31, 41 MAINTENANCE MANAGEMENT APPARATUSES
22, 23, 32, 42 LOG INFORMATION STORAGE UNIT
50 MAINTENANCE BASE PLACE
51 MAINTENANCE STAFF
60 COMMUNICATION LINE

What is claimed is:

1. A maintenance management apparatus comprising:
at least one memory storing instructions, and
at least one processor configured to execute the instructions to;
collect log information;
store log identifiers for identifying the log information, and time information of the log information while associating them with each other; and
create a log sequence in which the plurality of log identifies are arranged based on the time information, calculating a sequence time from a difference between a start time of the log sequence and an end time thereof, and grouping the log sequence into a sequence group in which the log sequence and the sequence time are associated with each other, wherein
when the sequence group matches neither with a pre-registered normal sequence group nor with a pre-registered abnormal sequence group, the instruction to create the log sequence calculates a predicted incident occurrence time based on a sequence group having a highest matching rate with the sequence group among pre-registered incident sign groups, the predicted incident occurrence time being a predicted time until an occurrence of an incident.

2. The maintenance management apparatus according to claim 1, wherein the at least one processor is further configured to execute the instructions to output the predicted incident occurrence time.

3. The maintenance management apparatus according to claim 1, wherein the instruction to create the log sequence acquires information about an output order of the log information from the time information, and generates the log sequence by sequencing the log identifiers based on the information about the output order.

4. The maintenance management apparatus according to claim 1, wherein when the log identifier corresponding to the log information is not registered, a new log identifier is assigned to the log information.

5. The maintenance management apparatus according to claim 1, wherein the instruction to create the log sequence calculates the matching rate by comparing the sequence group with the incident sign group while shifting the sequence group and the incident sign group a predetermined time at a time to the sequence time.

6. The maintenance management apparatus according to claim 1, wherein the time information is a time when the log information is collected.

7. A system comprising a maintenance management apparatus installed in a customer site, and a maintenance management apparatus installed in a maintenance center, the maintenance management apparatus installed in the maintenance center being connected to the maintenance management apparatus installed in the customer site, wherein
the maintenance management apparatus comprises:
at least one memory storing instructions, and
at least one processor configured to execute the instructions to;
collect log information;
store log identifiers for identifying the log information, and time information of the log information while associating them with each other; and
create a log sequence in which the plurality of log identifies are arranged based on the time information, calculating a sequence time from a difference between a start time of the log sequence and an end time thereof, and grouping the log sequence into a sequence group in which the log sequence and the sequence time are associated with each other, and
when the sequence group matches neither with a pre-registered normal sequence group nor with a pre-registered abnormal sequence group, the instruction to create the log sequence calculates a predicted incident occurrence time based on a sequence group having a highest matching rate with the sequence group among pre-registered incident sign groups, the predicted incident occurrence time being a predicted time until an occurrence of an incident.

8. The system according to claim 7, wherein the at least one processor is further configured to execute the instructions to output the predicted incident occurrence time.

9. A method comprising:
collecting log information;
storing log identifiers for identifying the log information, and time information of the log information while associating them with each other; and
creating a log sequence in which the plurality of log identifies are arranged based on the time information, calculating a sequence time from a difference between a start time of the log sequence and an end time thereof, and grouping the log sequence into a sequence group in which the log sequence and the sequence time are associated with each other, in which
when the sequence group matches neither with a pre-registered normal sequence group nor with a pre-registered abnormal sequence group, a predicted incident occurrence time is calculated based on a sequence group having a highest matching rate with the sequence group among pre-registered incident sign groups, the predicted incident occurrence time being a predicted time until an occurrence of an incident.

10. A non-transitory computer readable medium storing a program for causing a computer to:
collect log information;
store log identifiers for identifying the log information, and time information of the log information while associating them with each other; and
create a log sequence in which the plurality of log identifies are arranged based on the time information, calculate a sequence time from a difference between a start time of the log sequence and an end time thereof, and group the log sequence into a sequence group in which the log sequence and the sequence time are associated with each other, in which
when the sequence group matches neither with a pre-registered normal sequence group nor with a pre-registered abnormal sequence group, a predicted incident occurrence time is calculated based on a sequence group having a highest matching rate with the sequence group among pre-registered incident sign groups, the predicted incident occurrence time being a predicted time until an occurrence of an incident.
